(19) United States
(12) Patent Application Publication
(10) Pub. No.: US 2025/0329522 A1
(43) Pub. Date: Oct. 23, 2025

(54) Plasma EDD in Mass Spectrometry

(71) Applicant: DH Technologies Development Pte. Ltd., Singapore (SG)

(72) Inventors: Takashi BABA, Richmond Hill (CA); Kaoru KARASAWA, Tokyo (JP)

(21) Appl. No.: 18/870,113

(22) PCT Filed: May 19, 2023
(86) PCT No.: PCT/IB2023/055191

§ 371 Date: Nov. 27, 2024

Related U.S. Application Data
(60) Provisional application No. 63/347,808, filed on Jun. 1, 2022.

(51) Int. Cl. H01J 49/00; H01J 49/42

(52) U.S. Cl. CPC H01J 49/0031; H01J 49/0054; H01J 49/4225

(57) ABSTRACT

A method of performing negative electron activation dissociation (negative EAD) in mass spectrometry includes introducing a plurality of negatively charged analyte ions into an ion trap positioned in a chamber and trapping said negatively charged analyte ions in a reaction region of said ion trap, introducing a buffer gas into the chamber, using an electron source positioned in the chamber and external to the ion trap to generate electrons, and accelerating the electrons to form an electron beam and introducing the electron beam into the ion trap such that the accelerated electrons are capable of ionizing at least a portion of molecules of the buffer gas to generate a plurality of positively charged ions. The accelerated electrons interact with at least a portion of the analyte ions trapped in said reaction region to cause negative EAD thereof, thereby generating a plurality of fragment product ions.

### RELATED APPLICATIONS

This application claims priority to U.S. provisional application No. 63/347,808 filed on Jun. 1, 2022, entitled “Plasma EDD in Mass Spectrometry,” which is incorporated herein by reference in its entirety.

### TECHNICAL FIELD

The following relates to a mass spectrometer and more particularly to a mass spectrometer utilizing electron activation dissociation (EAD) including electron detachment dissociation (EDD) and negative electron induced dissociation (EID) applied to negatively charged analyte ions.

### BACKGROUND

Mass spectrometry (MS) is an analytical technique for determining the elemental composition of a substance. Specifically, MS measures a mass-to-charge ratio (m/z) of ions generated from a test substance. MS can be used to identify unknown compounds, to determine isotopic composition of elements in a molecule, to determine the structure of a particular compound by observing its fragmentation, and to quantify the amount of a particular compound in a sample. Mass spectrometers detect ions and as such, a test sample must be converted to an ionic form (i.e., precursor ions or analyte ions) during mass analysis. Generally, a mass spectrometer includes at least an ion source, a mass analyzer, and an ion detector. The ion source converts a test sample into gaseous ions, the analyzer separates the gaseous ions based on their m/z ratios, and the detector detects the separated ions.

A mass spectrometer can employ EAD to cause the fragmentation of analytes into smaller fragment ions (e.g., fragments containing individual nucleobases). These smaller fragment ions can then be mass analyzed and quantified based on their m/z ratios. EDD works on negatively charged multiply charged analyte ions, such as oligonucleotides, DNA, RNA, etc. Negative EID works on negatively charged singly charged analyte ions, such as acidic peptides, fatty acids and acidic complex lipids. As used herein, negative EAD includes both EDD and negative EID.

### SUMMARY

Aspects of the present disclosure address the problems disclosed herein and/or others.

In one aspect, a method of performing negative EAD in mass spectrometry is disclosed, which includes introducing a plurality of negatively charged analyte ions into an ion trap positioned in a chamber and trapping the negatively charged analyte ions in a reaction region of the ion trap. A buffer gas can be introduced into the chamber and an electron source positioned in the chamber and external to the ion trap can be used to generate electrons. The electrons can be accelerated to form an electron beam that can be introduced into the ion trap such that the accelerated electrons are capable of ionizing at least a portion of molecules of the buffer gas to generate a plurality of positively charged ions. Further, the accelerated electrons interact with at least a portion of the negatively charged analyte ions trapped in the reaction region of the ion trap to cause negative EAD thereof, thereby generating a plurality of fragment product ions. As discussed in more detail below, the positively charged ions can counteract a repulsion force exerted by the electrons on the negatively charged analyte ions to facilitate the retention of the negatively charged analyte ions within the reaction region of the ion trap.

In some embodiments, the ion trap can be a branched RF ion trap having a longitudinal passageway (herein also referred to as a longitudinal branch) extending from an inlet through which the negatively charged analyte ions can enter the trap to an outlet through which the fragment product ions can exit the ion trap. Such a branched RF ion trap can further include a transverse passageway (herein also referred to as transverse branch) intersecting the longitudinal passageway at the reaction region, where the transverse passageway has an inlet for receiving the electron beam. By way of example, the RF ion trap can include two sets of L-shaped rods that are axially separated from one another, where each set of the L-shaped rods is arranged according to a multipole configuration, e.g., a quadrupole, a hexapole, an octupole configuration.

In another aspect, a mass spectrometer includes an ion source for receiving a sample and ionizing one or more analytes in the sample to generate a plurality of negatively charged analyte ions, a chamber including a buffer gas and an ion trap for trapping the negatively charged analyte ions, an electron source positioned in the chamber and external to the ion trap for generating electrons, and a magnet positioned in the chamber for forming the electrons into an electron beam that is introduced into the ion trap. The electron beam is capable of ionizing at least a portion of the molecules of the buffer gas to generate a plurality of positively charged ions, and the electrons interact with at least a portion of the analyte ions to cause negative EAD thereof, thereby generating a plurality of fragment product ions.

In some embodiments, the ion source comprises an electrospray ion source and the mass spectrometer further includes a plurality of rods arranged in a multipole configuration to form an axial pathway and a transverse pathway that is perpendicular to the axial pathway, wherein the negatively charged analyte ions are introduced into the ion trap via the axial pathway and the electron beam is introduced into the ion trap via the transverse pathway. In some embodiments, the mass spectrometer also includes an RF voltage source for applying RF voltages to the plurality of rods. The plurality of rods can include a first set of rods and a second set of rods arranged in a quadrupole configuration. In some embodiments, the rods are L-shaped.

In some embodiments, the positively charged ions comprise any of a nitrogen molecular ion, a helium ion, a neon ion, and a krypton ion. In some such embodiments, the nitrogen molecular ion comprises N₂⁺ and N₂H⁺, said helium ion comprises Het, said neon ion comprises Ne⁺ and said krypton ion comprises Kr⁺. In some embodiments, electron kinetic energy is in a range of about 20 eV to about 90 eV depending on the gas species. The accelerated electrons can have a kinetic energy greater than about 20 eV, e.g., in a range of about 20 eV to about 50 eV in the case of nitrogen, neon, or krypton gas. The accelerated electrons can have a kinetic energy greater than about 50 eV, e.g., in a range of about 50 eV to about 90 eV in the case of helium gas.

### BRIEF DESCRIPTION OF THE DRAWINGS

Aspects of the present disclosure may take form in various components and arrangements of components, and in various steps and arrangements of steps. The drawings are only for illustration purpose of preferred embodiments of the present disclosure and are not to be considered as limiting.

Features of embodiments of the present disclosure will be more readily understood from the following detailed description take in conjunction with the accompanying drawings in which:

FIG. 1 schematically illustrates electrons of an electron beam and negatively charged analytes in accordance with an exemplary embodiment;

FIG. 2 schematically illustrates a mass spectrometer in accordance with an exemplary embodiment;

FIG. 3 schematically illustrates electrons being accelerated and positively charged ions in accordance with an exemplary embodiment;

FIG. 4 schematically illustrates electrons of an electron beam, positively charged ions, and negatively charged ions disposed within an ion trap in accordance with an exemplary embodiment;

FIG. 5 is a flow chart of a method of performing electron detachment dissociation (EDD) in mass spectrometry in accordance with an exemplary embodiment;

FIG. 6 is an exemplary EDD spectrum generated using a plasma technique disclosed herein; and

FIG. 7 is an exemplary negative EID spectrum; and

FIG. 8 schematically depicts a computer system in accordance with an exemplary embodiment.

FIG. 9A is a schematic illustration of a branched RF ion trap MS with permanent magnets.

FIG. 9B schematically depicts the DC bias along the electron beam path in the EAD devices.

FIG. 10 shows the characteristic spectra at Ke of 20 eV

FIG. 11A shows the Kₑ dependence of the production of charge reduced species.

FIG. 11B illustrates the N₂⁺ intensity produced in the EAD device.

FIG. 12A illustrates the Kₑ dependence and the fragments at Kₑ values of 18 eV and lower.

FIG. 12B shows the spectra at Kₑ=23 eV.

FIG. 12C shows the spectra at Kₑ=30 eV.

FIG. 12D shows the spectra at Kₑ=35 eV.

FIG. 13A-D show the MSMS spectra at 0, 20, 40, and 60 ms.

FIG. 14 shows normalized intensity data as a function of reaction times.

FIG. 15 shows the reaction time as a function of z.

FIG. 16 shows the normalized intensities vs. reaction times using (1/z)^{1.3} dependence.

FIG. 17A is an illustration of ions introduced into the EAD cell, which was produced in the gate1-filament 1 region.

FIG. 17B is an illustration of negative ETD of DNA16-PO without mutual precursor-reagent trapping in the conventional ETD operation.

FIG. 17C shows the reaction rate of the beam-type negative ETD.

FIGS. 18A-D are illustrations of the validation of the EDD model.

FIG. 19 shows that the energetic electron beam can induce strong EDD.

FIGS. 20A-H show the EDD spectra of DNA20-PS in various charge states of z.

FIGS. 21 and 22A-J show the EDD spectra with fragment density charts for all fragments.

FIGS. 23A-C show that when PS was partially substituted in DNA-PO around the termini (DNA20-POPS), the fragments cleaved at the PS portions were 100 times more intense than those at the PO.

FIGS. 24A-E show that when PS was partially substituted in DNA-PO around the termini (DNA20-POPS), the fragments cleaved at the PS portions were 100 times more intense than those at the PO.

FIGS. 25A-B illustrate that even with weak intensities at the PO portions, the spectrum can be sequenced using a^{⋅} and w fragments.

FIGS. 26A-C illustrate that CID does not show a significant PO/PS difference in dissociation efficiency.

FIGS. 27A-E and 28A-H show the fragment intensity charts of oligonucleotides with locked ribose near the termini.

FIG. 29 illustrates the plasma EDD spectra.

FIGS. 30A-B and 31A-C illustrate the b, c, d, x, and y fragments generated via CID.

FIGS. 32A-C and 33 illustrate the survey of impurities in the degraded GAP sample.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed at any great detail. One of ordinary skill will recognize that some embodiments of the present disclosure may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and, “substantially, and “substantially equal” refer to variations in a numerical quantity and/or a complete state or condition that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

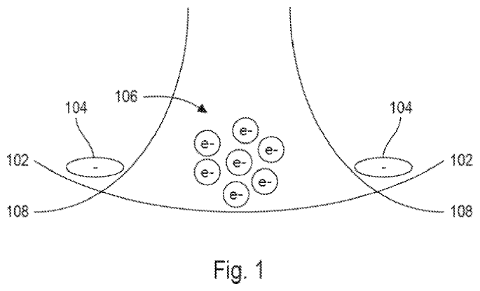

The present disclosure generally relates to a mass spectrometer. As noted above, a mass spectrometer can employ negative EAD to fragment analytes (e.g., oligonucleotides, DNA, RNA, acidic peptides, fatty acids, acidic complex lipids, etc.) into smaller fragment ions. A mass spectrometer utilizing negative EAD retains negatively charged analyte ions within an ion trap. These mass spectrometers also employ an electron beam that collides with the negatively charged analyte ions within the ion trap. The collision causes the negatively charged analyte ions to fragment. As depicted in FIG. 1, an ion trap potential (or pseudo potential generated by the RF field) 102 can be used to confine a plurality of negatively charged analyte ions 104 in radial direction and an electron beam can be introduced into the ion trap to interact with the trapped negatively charged analyte ions so as to cause their fragmentation via negative EAD. The electrons 106 in such an electron beam produce an electric potential 108 that may repel the negatively charged analyte ions 104 thereby reducing the number of collisions between negatively charged analyte ions 104 and electrons 106, and hence reduce the efficiency of the EDD of the negatively charged analyte ions. As such, there is a need for negative EAD mass spectrometer with increased collision efficiency between the negatively charged analyte ions and the electron beam.

In one aspect, the present disclosure relates to methods for performing mass spectrometry and mass spectrometers that may be utilized to practice such methods. These methods include trapping a plurality of negatively charged analyte ions within an ion trap and introducing an electron beam and positively charged ions into the ion trap. In some embodiments, introducing both a negatively charged electron beam and positively charged ions can create a substantially electrically neutral environment within the trap, i.e., neutral plasma. This neutral environment can facilitate the retention of negatively charged analyte ions within a reaction region (e.g., the center) of the ion trap, which can increase the number of collisions between the electrons of the electron beam and the negatively charged analyte ions.

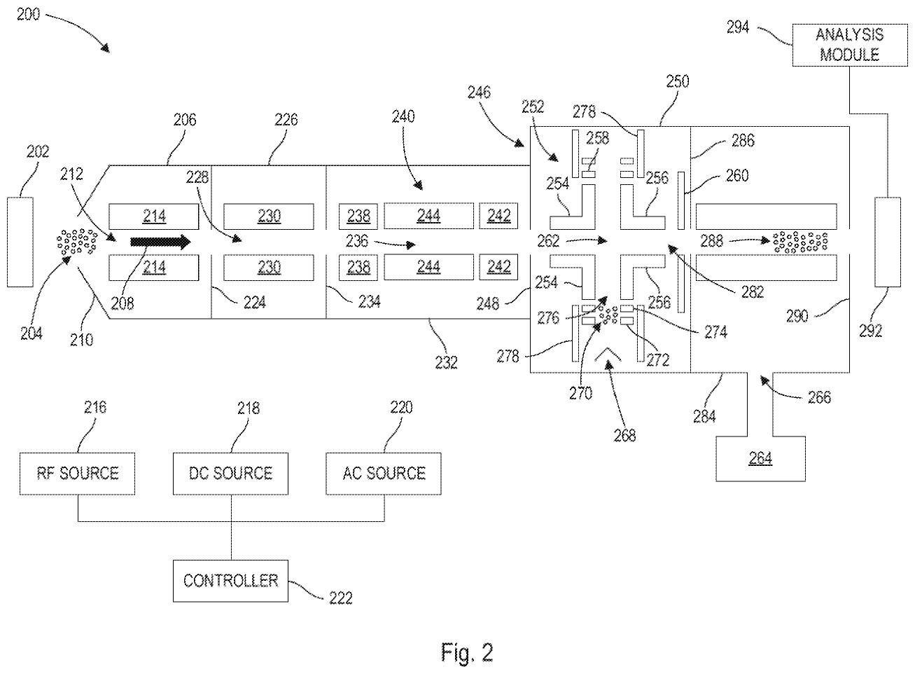

FIG. 2 schematically depicts a mass spectrometer 200 in accordance with an exemplary embodiment.

In this embodiment, the mass spectrometer 200 includes an electrospray ion source 202 that generates a plurality of negatively charged analyte ions 204. The ion source 202 is in communication with a sample holder (not shown) which provides analytes (e.g., oligonucleotides etc.) to the ion source 202. The mass spectrometer 200 also includes a vacuum chamber 206 that is in communication with the ion source 202. The charged analyte ions 204 travel in the direction of arrow 208 and pass through an aperture of a curtain plate 210 to enter the vacuum chamber 206.

Once within the chamber 206, the charged analyte ions 204 pass through a differential pumped region 212 that is disposed within the vacuum chamber 206. The differential pumped region 212 includes a plurality of rods 214, which are arranged in a quadrupole configuration in this embodiment.

The mass spectrometer 200 further includes an RF voltage source 216, a DC voltage source 218, and an AC voltage source 220 that are each under operation of a controller 222. The RF voltage source 216 can apply RF voltages to the rods 214 so as to generate an RF electric field. The RF electric field, in combination with gas dynamics, can focus the charged analyte ions 204 into an ion beam for transmission to downstream components of the mass spectrometer.

The charged analyte ions 204 pass through the ion guide (QJet) region 212 and are further focused by an IQ0 lens 224 and enter a vacuum chamber 226. The charged analyte ions 204 continue in the direction of arrow 208 and pass through an ion guide (Q0) in another differential pumped region 228. In this embodiment, the ion guide includes four rods 230 (only two of which are shown in FIG. 2) that are arranged in a quadrupole configuration. The RF voltage source 216 is electrically connected to rods 230 and supplies RF voltages to the rods 230 so as to generate an RF electric field for providing radial confinement of the ions in proximity of the central axis of the rods 230.

The charged analyte ions 204 continue propagating in the direction of arrow 208 and enter a vacuum chamber 232 via an IQ1 ion lens 234. Once within the vacuum chamber 232, the charged analyte ions 204 pass through a Q1 region 236 that is disposed within the vacuum chamber 232. The Q1 region 236 includes Brubaker lens (or a stubby lens) 238, a quadrupole mass filter 240, and a stubby lens 242. The stubby lens 238 is positioned upstream form the mass filter 240 and the stubby lens 242 is positioned downstream form the mass filter 240. The quadrupole mass filter 240 includes a plurality of rods 244 that are arranged in a quadrupole configuration (only two of which are shown in FIG. 2). The stubby lens 238 focuses charged analyte ions 204 exiting the vacuum chamber 226 into the mass filter 240.

The application of RF voltages as well as a resolving DC voltage to the rods of the quadrupole mass filter 240 provides radial confinement of the ions and further allows selecting analyte ions with a target m/z range of interest to pass through the quadrupole mass filter 240 and be focused via the stubby lens 242 into a dissociation device 246 that is positioned downstream from the mass filter 240. The charged analyte ions 204 enter the dissociation device 246 via an IQ2 lens 248 that further focuses the charged analyte ions 204.

The dissociation device 246 includes a chamber 250 in which an ion trap 252 is disposed. The ion trap 252 is defined by first L-shaped electrodes 254 and second L-shaped electrodes 256 (also referred to as L-shaped rods 254 and 256 respectively) that are axially separated from one another, an electrode 258 (e.g., a lens electrode), and optionally an electrode 260. At the center of the ion trap 252 is reaction region 262. While FIG. 2 shows the mass spectrometer 200 as including the electrode 260, in other embodiments the electrode 260 may be omitted.

In this embodiment, the first L-shaped electrodes 254 and second L-shaped electrodes 256 include four electrodes (only two of which are shown in FIG. 1) that are arranged in a quadrupole configuration and are axially separated from one another to provide the ion reaction region 262 therebetween. The first L-shaped electrodes 254 and second L-shaped electrodes 256 form an axial pathway (in the direction of arrow 208) through which the charged analyte ions 204 may pass. Further, the arrangement of the first L-shaped electrodes 254 and second L-shaped electrodes 256 forms a transverse pathway that is perpendicular to the axial pathway. The ion trap 252 formed by the first L-shaped electrodes 254 and second L-shaped electrodes 256 may be referred to as a “branched ion trap.”

The RF voltage source 216 and the DC voltage source 218 operating under control of the controller 222 supply voltages to the L-shaped electrodes 254 and 256 which trap the negatively charged analyte ions 204 within the ion trap 252. In this embodiment, since the first L-shaped electrodes 254 and second L-shaped electrodes 256 are supplied with an RF voltage, the ion trap 252 may be referred to as a “branched RF ion trap.”

The electrode 258 and an electrode 274 are positioned in proximity of openings of the transverse pathway defined by the first L-shaped electrodes 254 and second L-shaped electrodes 256. The DC voltage source 218 can be used to apply a DC voltage to the electrodes 258 and 274 so as to maintain the electrodes 258 and 274 at an electric potential that would inhibit the negatively charged analyte ions 204 (e.g., oligonucleotides) from leaking out of the ion trap 252 via the transverse pathway. Accordingly, the electrode 274 further defines the ion trap 252.

The mass spectrometer 200 includes a gas reservoir 264 that is in communication with the chamber 250. The gas reservoir 264 supplies a neutral buffer gas (e.g., neon, krypton, helium, nitrogen, argon, etc.) to the chamber 250 via an input port 266.

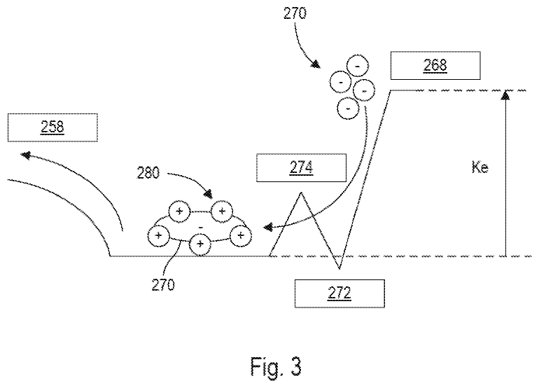

With reference to FIGS. 2 and 3, the mass spectrometer 200 also includes a thermal electron source 268 (e.g., a filament) that generates a plurality of electrons 270, a gate electrode 272 and a pole electrode 274 that are positioned between the electron source 268 and an inlet 276. In this embodiment, the mass spectrometer 200 can further include magnets 278 that are configured to generate a magnetic field extending from the electron source 268 to the pole electrode 258 across the trap center 262 to confine the electrons and form an electron beam.

The DC voltage source 218 can also apply DC voltages to the gate electrode 256 and the pole electrode 272 such that the gate electrode 256 is positively biased relative to the electron source 268. The bias of the electron beam source 268 is set in a range of about −20 to −50 volts relative to the branched ion trap. In these cases, the accelerated electrons can have a kinetic energy greater than at least 20 eV and specifically can have a kinetic energy in a range of about 20 eV to about 50 eV (e.g., 30 eV, 35 eV, 40 etc.) in the ion trap 252. In some embodiments, the controller 222 controls the temperature of the electron source 268 to increase or decrease a current associated with the emitted electrons 270. By way of example, the current generated by the electrons 270 may be in a range of about 10 to about 100 microamps.

The electrons 270 are introduced into the ion trap 252 as an electron beam via the inlet 276 of the transverse pathway. By way of example, the electron beam can have a diameter of about 1 mm. The electrons 270 ionize molecules disposed within the ion trap 252 via electron impact ionization (EI), thereby generating a plurality of positively charged ions 280 (e.g., N₂⁺, He⁺, Ne⁺, Kr⁺, etc.) within the reaction region 262 of the ion trap 252. The positive charge of the ions 280 can neutralize the negative charge of the electron beam 270 thereby providing a substantially electrically neutral plasma, thereby reducing, and preferably eliminating, the repulsive forces experienced by the negatively charged ions 204 via interaction with the electron beam.

Typically, when electrons alone are introduced into an ion trap, the electrons can produce a negatively charged environment within a reaction region of the ion trap into which the electrons are introduced. The negatively charged environment can repel negatively charged analyte ions. Such a repulsion may expel the negatively charged analyte ions from the reaction region of the ion trap before the analyte ions may interact with the electrons. As a result, in many cases, the fragmentation of the negatively charged analyte ions via negative EAD may be minimal. The present teachings overcome this difficulty by ionizing, via the same electron beam utilized for negative EAD, a plurality of gas molecules introduced into the ion trap so as to generate a plurality of positively charged ions, which can substantially neutralize the electric field generated by the electrons, thereby facilitating the retention of the negatively charged analyte ions within the reaction region of the ion trap and hence improve the efficiency of negative EAD of the negatively charged analyte ions. In some embodiments, the electron beam has a kinetic energy sufficient to provide an electrostatic potential well for confining at least a portion of the positively charged ions within the reaction region

Without being limited to any particular theory, the improved retention of the analyte ions within the reaction region can result in an increase in the number of collisions between the electrons and the negatively charged ions, and hence an increase in the probability of fragmentation of the negatively charged analyte ions via negative EAD. Furthermore, the faster reaction rate associated with negative EAD relative to a reaction rate associated with an electron transfer reaction can facilitate the fragmentation of the negatively charged analyte ions before they leave the reaction region of the ion trap.

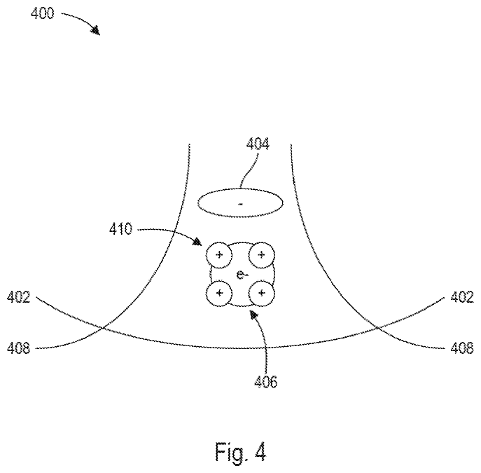

By way of further illustration, the above process is depicted schematically in FIG. 4. In this example, an RF potential 402 confines negatively charged analyte ions 404 within an ion trap 400 and electrons 406 of an electron beam produce a potential 408 that would ordinarily repel the negatively charged analyte ions 404. In this example, positively charged ions 410 generated via ionization of the buffer gas molecules introduced into the ion tap 400 can counteract, and preferably neutralize, the potential 408 (e.g., cause the potential to vanish) thereby allowing negatively charged analyte ions 404 to enter and be retained within the path of the electron beam.

Referring again to FIGS. 2 and 3, the pole electrodes 274 and 258 are negatively biased relative to center 262 of the ion trap 252. That is, the pole electrodes 274 and 258 are negatively biased relative to the first L-shaped electrodes 254 and second L-shaped electrodes 256. This negative bias of the pole electrodes prevents the negatively charged analyte ions 204 from escaping the ion trap 252 via the inlet 276 while allowing the negatively charged electrons 270 to enter the ion trap 252.

The electrode 260 is positioned in proximity of an axial outlet 282 of the ion trap 252. The AC voltage source 220 supplies an AC voltage to the electrode 260 which generates a pseudopotential barrier that contains the negatively charged analyte ions 204 within the trap 252. However, fragment ions of interest (e.g., fragment ions having a certain m/z ratio) can overcome the AC pseudopotential barrier to enter the downstream Q2 collision cell 284 via an aperture of an IQ2 lens 286. In the collision cell, fragment ions 288 collide with buffer gas molecules supplied by the gas reservoir 264. These collisions result in cooling of the fragment ions 288. The fragment ions 288 continue propagating in the direction of arrow 208 and exit the collision cell 284 via passage through an aperture of a lens 290. In some embodiments wherein the electrode 260 is omitted, the lens 286 is opened to extract the fragment ions 288 from the reaction device 250 to the mass analyzer 292 after the negative EAD is applied.

The mass spectrometer 200 further includes a mass analyzer 292 (e.g., a time-of-flight (TOF) analyzer or another type of mass analyzer) positioned downstream from the collision cell 284 that receives the fragment ions 288 and provides mass spectral data associated with the fragment ions 288. An analysis module 294 receives the mass spectral data generated by the mass analyzer 292 and processes the data to generate a mass spectrum of the fragment ions 288 and correlates the mass spectrum of the fragment ions 288 with negatively charged analyte ions 204 from which the fragment ions 288 were generated.

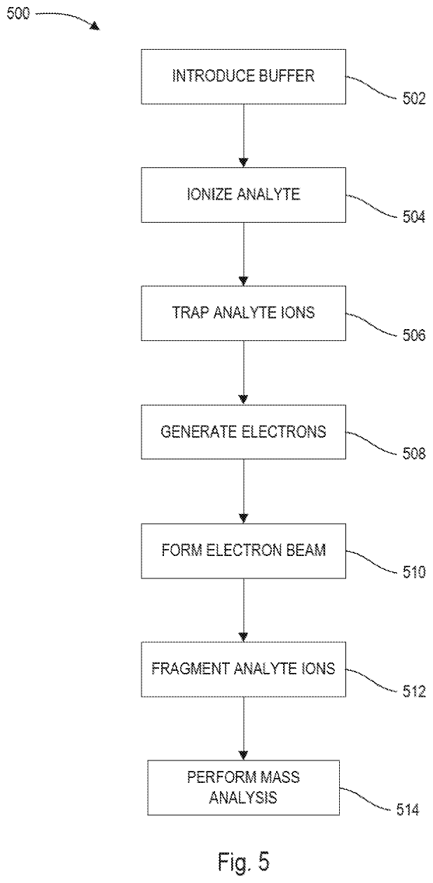

Referring now to FIG. 5 a method 500 of performing electron detachment dissociation (EDD) and negative electron induced dissociation (EID) in mass spectrometry is shown in accordance with an exemplary embodiment.

At 502, a buffer gas is introduced into a chamber of a reaction device as previously discussed herein.

At 504 an analyte (e.g., an oligonucleotide) is ionized to generate a plurality of negatively charged analyte ions as previously discussed herein.

At 506, the negatively charged analyte ions (isolated single m/z species, roughly isolated in wide range of m/z values, or non-isolated) are introduced and trapped into an ion trap positioned in the chamber of the reaction device as previously discussed herein.

At 508, an electron source (e.g., a thermal filament) external to the ion trap generates electrons as previously discussed herein.

At 510, the electrons are accelerated to form an electron beam and the electron beam, is introduced into the ion trap. When in the trap, the electron beam ionizes at least a portion of the buffer gas molecules to generate positively charged ions within the trap and further interacts with at least a portion of the negatively charged analyte ions trapped in the ion trap to cause fragmentation of at least a portion thereof via EDD or negative EID, thereby generating a plurality of fragment product ions.

At 514, a mass analyzer receives the fragment product ions and generates mass spectral data corresponding to m/z ratios of the ions as previously discussed herein. Furthermore, at 514 an analysis module receives the mass spectral data generated by the mass analyzer and processes the data to generate a mass spectrum of the fragment ions and correlates the mass spectrum of the fragment ions with negatively charged analyte ions from which the fragment ions were generated as previously discussed herein.

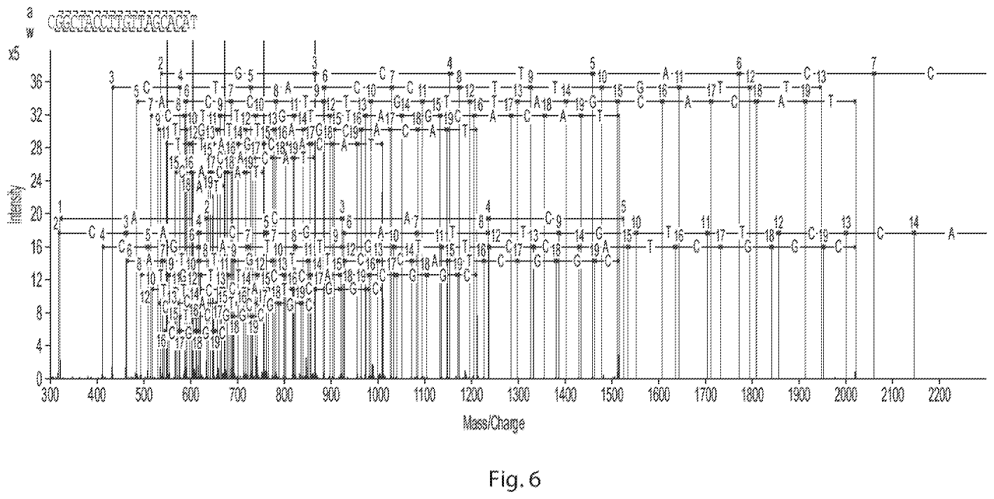

Referring now to FIG. 6, an example of an EDD spectrum using the disclosed plasma technique is shown. In this example deprotonated DNA samples were irradiated by an electron beam with Ke=35 eV for 20 ms in nitrogen gas. The a^{⋅} and w fragments were dominant in the EDD spectrum. The obtained sequence coverage was 100%.

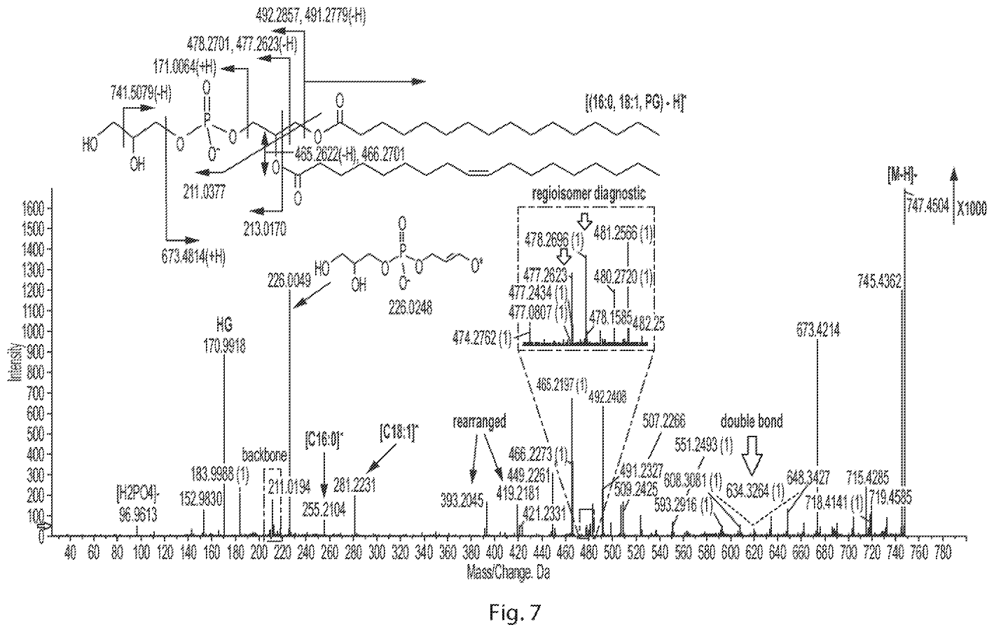

Referring now to FIG. 7, an example of a negative EID spectrum, wherein negative EID was applied to acidic phospholipids, is shown. In this example, deprotonated phosphatidylglycerol (PG) samples were irradiated by an electron beam with Ke=35 eV in nitrogen gas. The complete structural information of the lipids was displayed in a single spectrum.

The data associated with the following examples was acquired using a research grade Sciex mass spectrometers configured in accordance with the present teachings.

### EXAMPLES

The following examples further illustrate some of the presently disclosed embodiments.

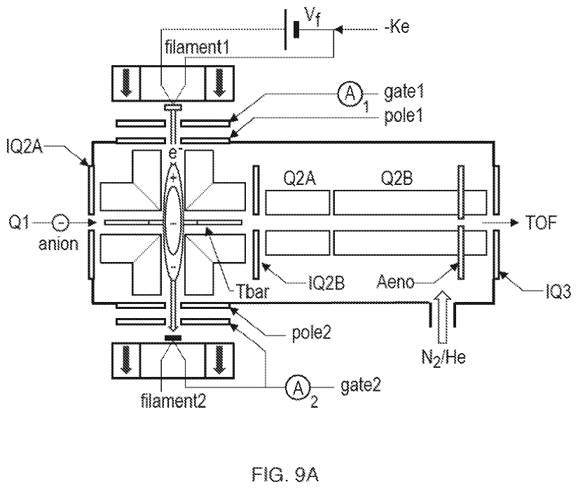

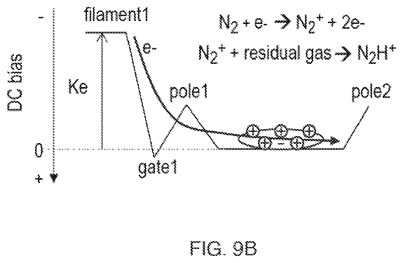

In these examples, the EAD cells used for collecting the data discussed below were branched RF ion traps with permanent magnets as shown schematically in FIG. 9A.

In one set of experiments, a research grade EAD-TOF instrument was employed and in other experiments a commercial system was employed. The branched RF ion trap is a six-way-cross RF ion trap that includes eight L-shaped electrodes. Six DC lenses, which were negatively biased, were installed to confine the negative ions in the six axial directions.

The RF frequency for operating the EAD cell in the commercial grade system was 800 KHz. The RF frequency for operating the EAD cell in the research grade TOF instrument was set to 600 kHz in order to confine higher mass-to-charge (m/z) ratio ions.

Two N52 grade neodymium magnets provided a magnetic field of about 300 mT along the electron beam axis. The buffer gas was introduced into the Q2 and the EAD cell, where the pressure in the EAD cell was nearly the same as that in the Q2 cell because four holes with a diameter of 5 mm were provided on the IQ2B lens to achieve a high gas conductance. Nitrogen was used as the buffer gas (CAD) in the commercial instrument.

A Y₂O₃-coated iridium disk (Kimball Physics, NH) was Joule-heated at a constant voltage of V_{f} to produce the thermal electron beam. Electron beam energy (Kₑ) is defined by the bias of the iridium disk relative to the DC bias of the branched ion trap electrodes. An ammeter (A1), which measures a voltage drop across a resistor, was inserted in the gate1 line to monitor the electron beam generation used in the commercial system. Another ammeter (A2) was inserted in the shorted filament2-gate2 line to measure the electric current traveling across the EAD device, which was available in the research grade instrument.

The EAD cell was installed between Q1 and Q2 in a Q-TOF mass spectrometer. Zeno trap pulsing was off in all experiments in which the research grade instrument was used in order to avoid saturation of the ion detection system by intense species. The EAD cell in the Zeno trap system was operated in simultaneous trapping mode (or quasi flow-through mode). A proprietary OS software was used for obtaining data at Ke values greater than 20 eV. Zeno trapping was activated in experiments performed using the commercial system.

FIG. 9B schematically depicts the DC bias along the electron beam path in the EAD devices.

### I. Production of Positive Ions

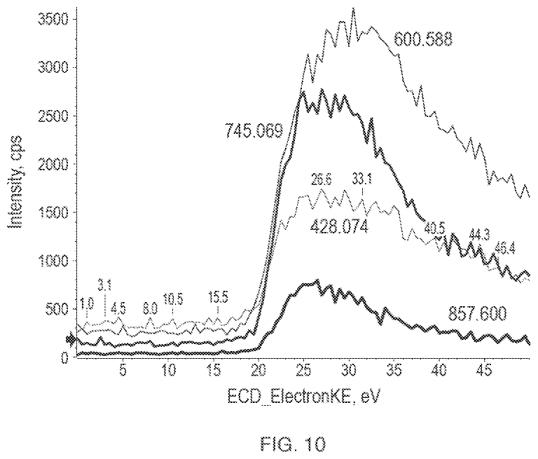

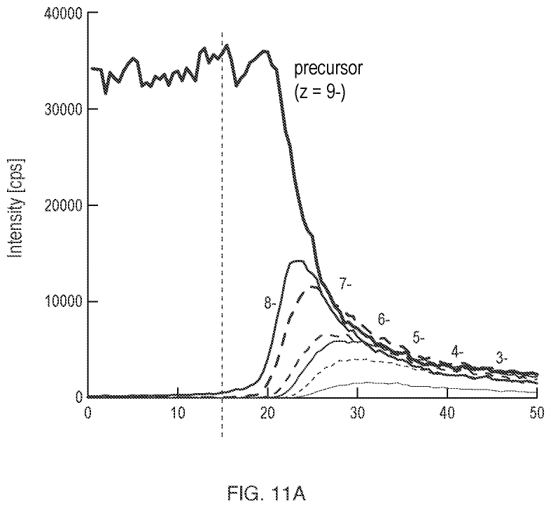

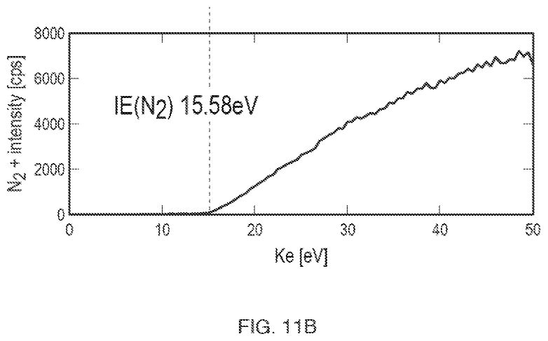

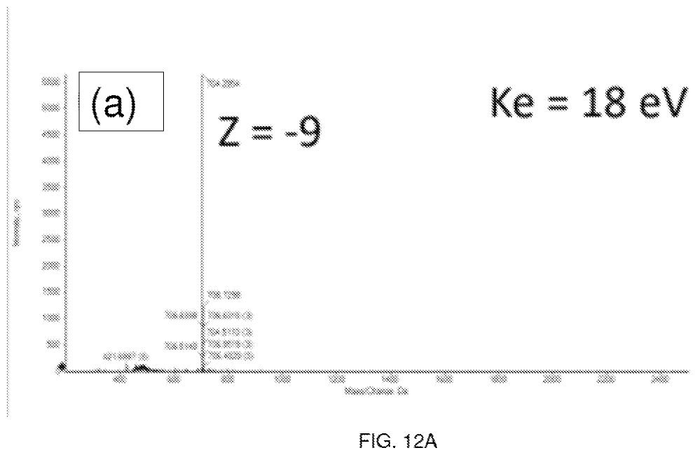

The charge state of z=9⁻ of DNA20-PS: [M—9H]⁹⁻ was irradiated by the electron beam for 10 ms in simultaneous trapping mode. The nominal electron beam intensity was set at 3000 nA at A1. FIG. 11A shows the Kₑ dependence of the production of charge reduced species (CRS) and the characteristic spectra at Kₑ=18, 23, 30, and 35 eV are shown in FIG. 10.

CRS: [M—nH]⁽ⁿ⁻¹⁾⁻ can be produced by electron detachment or electron transfer as shown below:

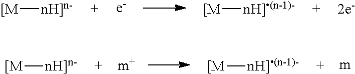

As shown in FIG. 11A, the charge reduction of n=9 started at 10 eV, and the production of CRS gradually increased, in which Kₑ was lower than the ionization energy (IE) of N₂: 15.58 eV. As shown in FIG. 11B, N₂⁺ was produced in the EAD device when Kₑ was higher than the IE of N₂.

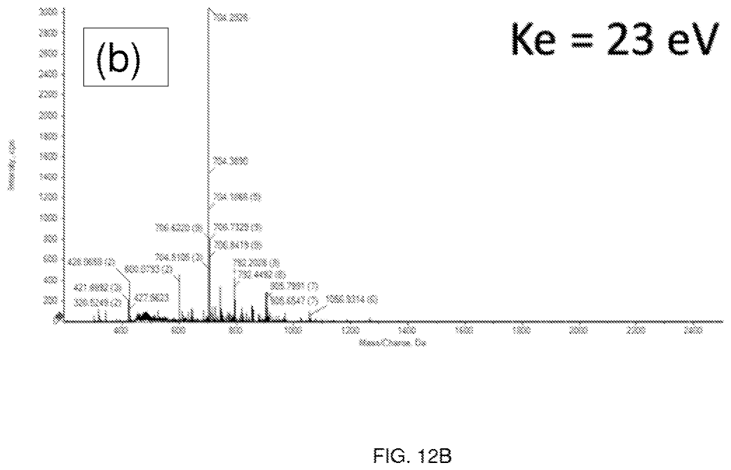

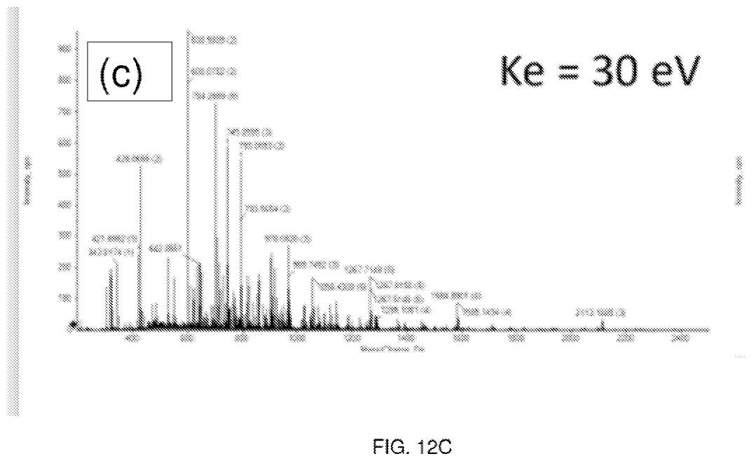

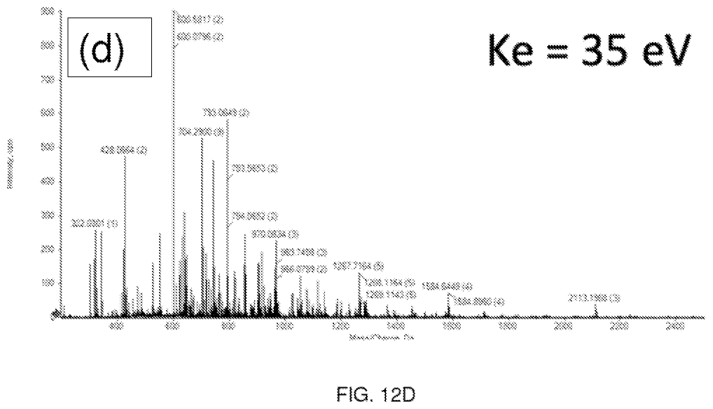

At Kₑ values of 18 eV and lower, the spectrum contained the precursor ions dominantly and the fragments were still weak, as shown in FIG. 12A. The precursors were consumed strongly at Kₑ=18 eV, and CRS production (z=8) was dramatically increased. This sudden change in the CRS production for electron energies higher than IE is consistent with the notion that the dense N₂⁺ ions play an important role in precursor consumption.

The first CRS (z =8-) exhibited a maximum at Kₑ=23 eV when the consumption of the precursor ions was 62%. Th spectrum at Kₑ=23 eV is shown in FIG. 12B. The fragments were visible in the same scaling as the remaining precursor ions. The intensity of the first CRS exhibited a decrease at higher Kₑ values because the second charge reduction consumed the CRS. The product intensities were maximized at Kₑ of about 30 eV (e.g., FIG. 12C) at which the third CRS (z=−6) reached the maximum. FIG. 12C\D shows the spectra at Kₑ=35 eV, where the peak intensities were lower than for Kₑ=30 eV, but with a similar profile.

### II. Measurements of Charge Reduction Rate

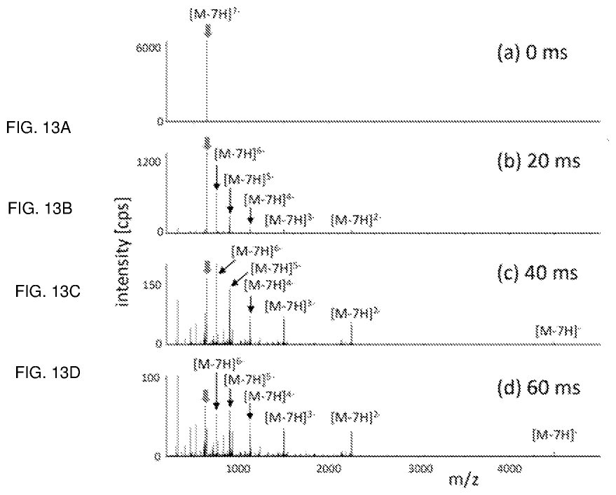

The progress of charge reduction as a function of electron irradiation time was observed to obtain the charge reduction rate for each of the charge states. (dT)₁₅ was irradiated by the electron beam at a Kₑ=40 eV. Conventional trapping mode was programmed with a fixed ion loading time of 50 ms and a variable reaction time from 0 to 60 ms. A blank period was inserted after the ion extraction to keep the total duration of the scan function constant. FIG. 13A-D show the MSMS spectra at 0, 20, 40, and 60 ms, and FIG. 13C shows the intensity changes of each CRS with the vertical scale normalized, illustrating that cascading charge reduction was observed.

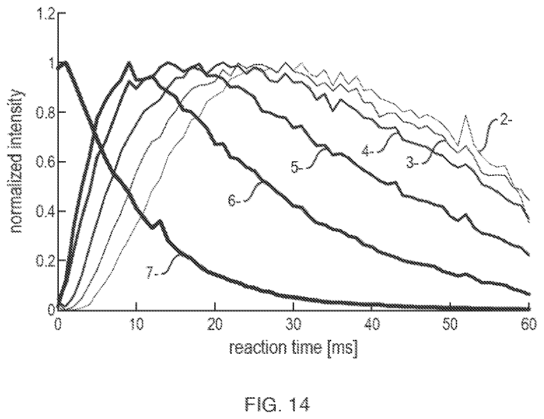

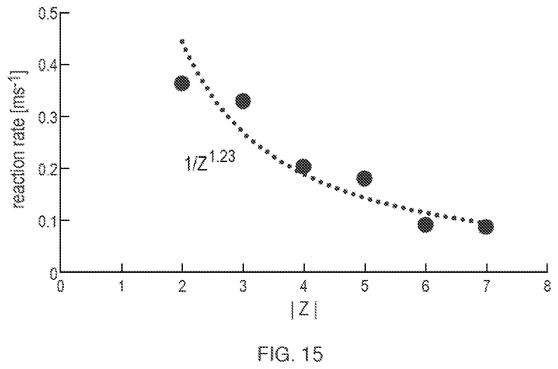

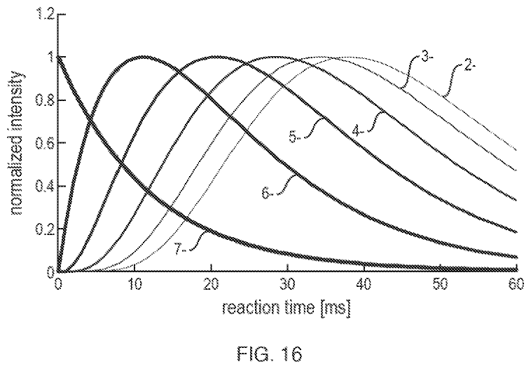

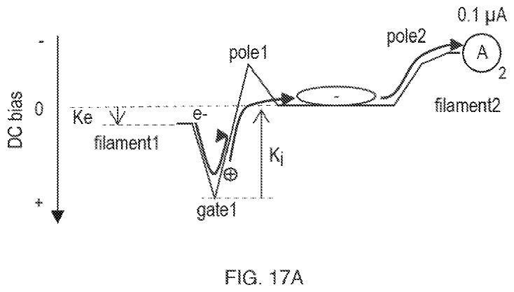

Using the data in FIG. 14, the reaction rate associated with each charge state was calculated, as shown in FIG. 15. The observed charge reduction rate has a (1/z)^{1.3} function form with the higher charge states exhibiting lower charge reduction rates, which is opposite to the well-known z² dependence of reaction rate on charge state for ECD (electron collision dissociation) applied to multiply protonated peptides and proteins. FIG. 14 was reproduced using the (1/z)^{1.3} dependence as shown in FIG. 16.

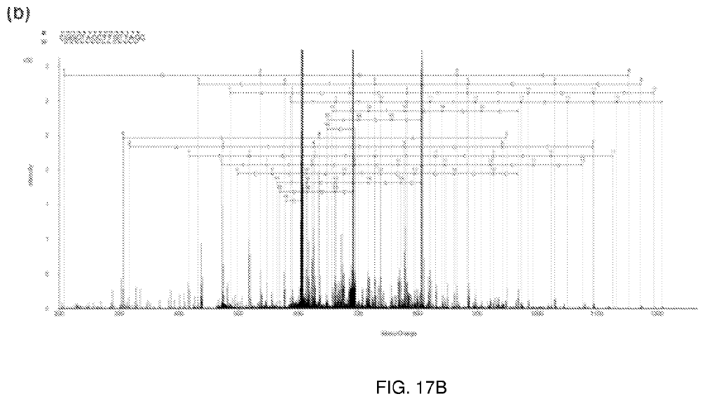

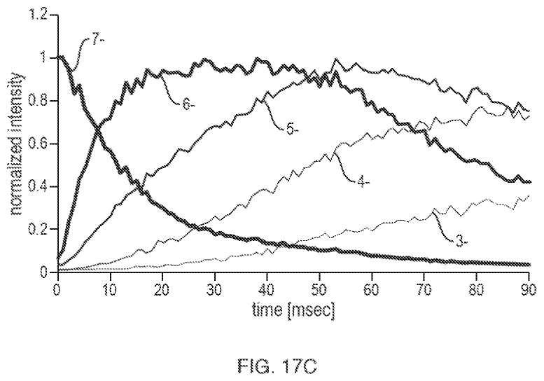

If the charge reduction is caused by electron transfer, the reaction speed of higher charge states should be faster because of the attractive cation-anion interaction. Experiments were performed to examine negative ETD (electron transfer dissociation). Specifically, with reference to FIG. 17A, N₂⁺ ions were introduced into the EAD cell, which was produced in the gate1-filament 1 region. The bias voltage applied to the filament was set so as to inhibit the entry of the electrons into the trap. Although N₂⁺ ions were not stable in the RF field because of the low mass cutoff (LMCO), the nitrogen ion beam travelled across oligonucleotide precursors. A positive electric current of 0.1 μA was measured at the second filament, which operated as a Faraday cup. Negative ETD of DNA16-PO was confirmed (as seen in FIG. 17B), without mutual precursor-reagent trapping in the conventional ETD operation.

FIG. 17C shows the reaction rate of the beam-type negative ETD. The reaction speeds were faster for highly charged precursors and slower for lowly charged states, which was consistent with the anion-cation interaction with the z² dependence (FIG. 13D), i.e., it was opposite to the results of the electron beam irradiation (FIG. 15). The results provided in FIG. 15 shows that the enhanced dissociation mechanism is based on EDD.

### III. Neutralization of the Electron Beam Potential

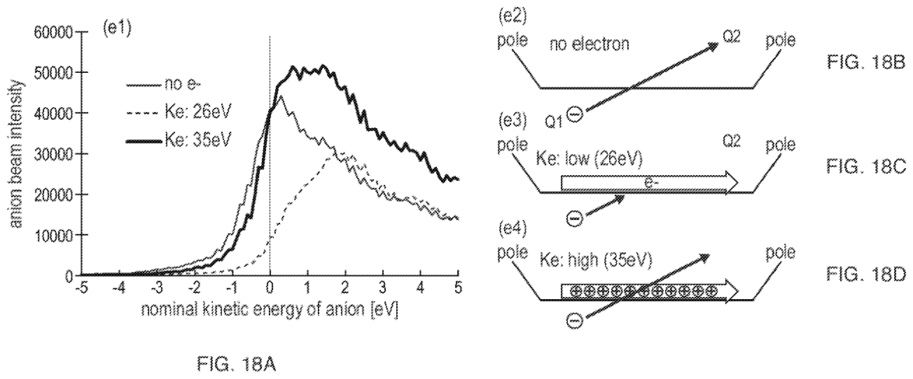

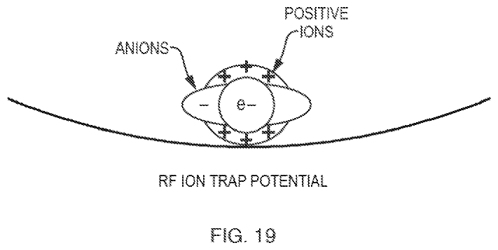

With reference to FIGS. 18A-D, the EDD model was validated. In other words, it was confirmed that the positive ions help neutralize the electron beam potential. The height of the potential generated by the electron beam was measured using probe anions. The probe anion (m/z =−166), which was produced by electron spray ionization (ESI), was injected into the electron beam after being isolated by Q1. The ToF analyzer monitored the transmitted anions through the electron beam. The kinetic energy of the probe anions was ramped in a manner similar to the ramping of the collision energy (CE) in CID operation. The blue curve in FIG. 18A corresponds to the electron beam being off. Th tail in the negative CE side shows the kinetic energy distribution of the probe anions. When Kₑ was set at 26 eV (the orange curve), at which the electron beam did not induce dissociation in (dT)₁₅, the transmission of the probe anions was disturbed by the electron beam potential so that higher kinetic energy (+2 eV) was required for transmission. When Kₑ was set at 35 eV (the black curve), the transmission of the probe anions was recovered, and the profile became nearly the same as that in the no-electron case. This indicated the electron beam potential at Kₑ=35 eV was equivalent to no electrons, i.e., the N₂⁺ cations should have canceled the electron beam potential. The energetic electron beam can induce strong EDD as depicted schematically in FIG. 19.

It was observed that N₂H⁺ was produced from N₂⁺ by ion-neutral reaction with the residual vacuum gas. N₂⁺ and N₂H⁺ (m/z of 28 and 29, respectively) were trapped in the plasma EDD condition though these ions were out of the stability of the RF ion trap as a high RF amplitude was frequently applied, which was equivalent to LMCO of 200 m/z. However, the trapping of nitrogen ions by the electron beam was still achieved as the typical electron beam intensity was 50 μA at A2 such that the calculated depth of the electron beam potential was about 1 V for positive ions.

Without being limited to any particular theory, the predominance of EDD relative to ETD in a plasma containing N₂⁺ cations may be explained by assuming that 10¹⁰ ions are produced per 10 ms, which can fill the electron beam trap instantly with the overflow of the cations being swept out by LMCO when the ions are pushed out by the electron beam. On the other hand, the electron beam at 50 μA provides 10¹² electrons per 10 ms, which is 1 million times greater than the number of cations, which could result in the EDD being the dominant process.

### IV. Chemistry of Plasma EDD

In various embodiments, the dissociation efficiency of the intermediate states produced by electron detachment is a parameter that can be employed for evaluating EDD efficiency. This can inform the selection of a charge state from various precursor charge states produced by ESI to achieve a good sequence coverage in oligonucleotide dissociation. In CID, lower-charged precursor states provide better coverage because the production of internal fragments is less than that in the higher charged precursor states, however, the sensitivity can be low because such lower-charged precursors are typically in low abundance in ESI products.

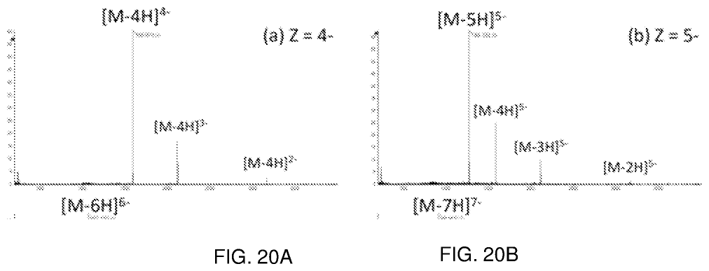

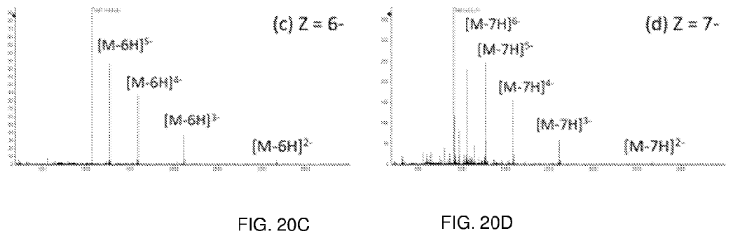

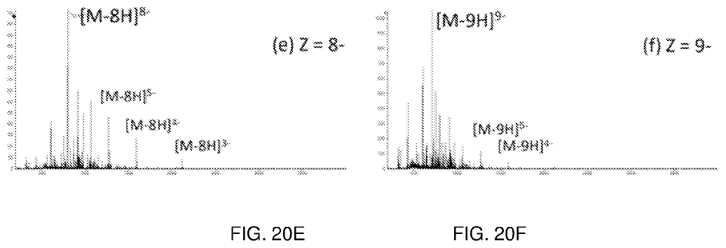

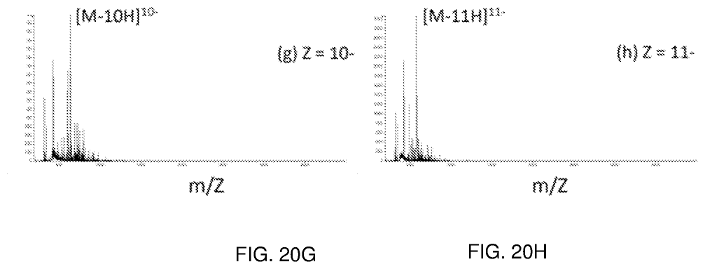

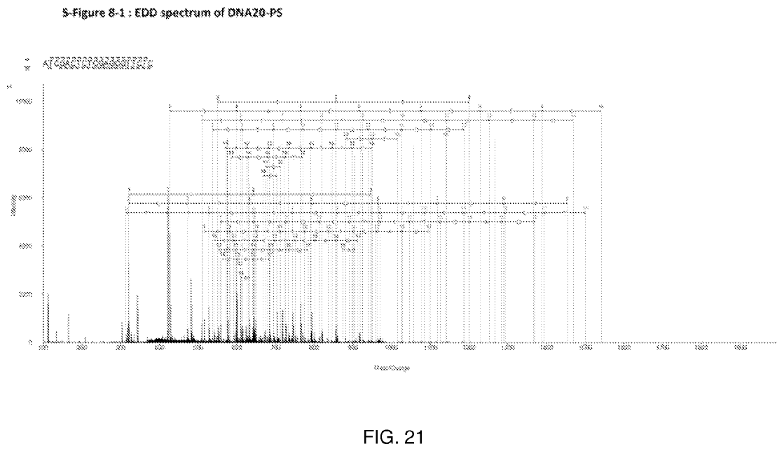

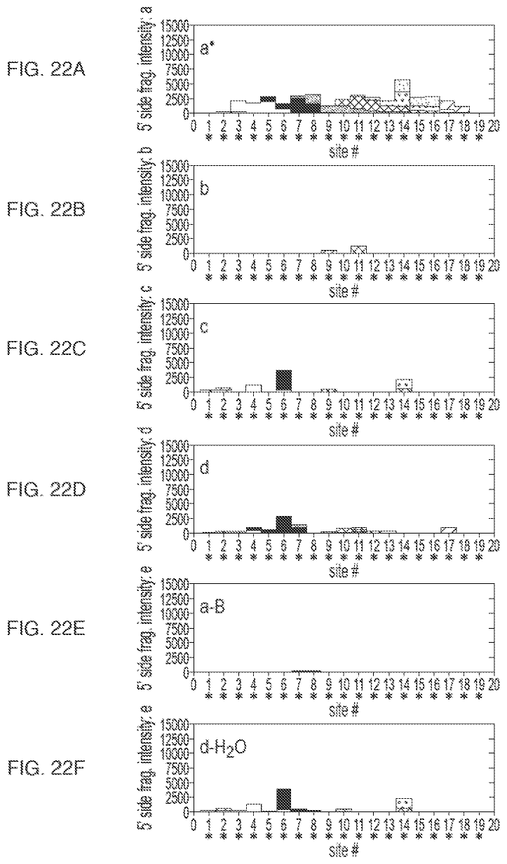

The EDD applied to various precursor charge states was examined. FIGS. 20A-H show the EDD spectra of DNA20-PS in charge states of z=4⁻, 6⁻, 8⁻ and 10⁻, respectively, irradiated by the electron beam with K^{e}=25 eV. FIGS. 20A-H also show the EDD of DNA20-PS with various precursor charge states in K^{e}=35 eV and 45 eV. In particular, FIG. 20G shows a single-charge-converted annotated spectrum of the precursor charge states of z=10⁻ at K^{e}=25 eV. FIGS. 20A-H show that highly charged ions produced rich fragments and lower-charged ions produced almost no fragments, which is similar to ECD in peptides and proteins. Again, without being limited to any particular theory, the strong intermolecular tension by the dense charge helps in dissociation. A significant Kₑ dependence was not observed on dissociation patterns.

### V. Dissociation of Modified Oligonucleotides

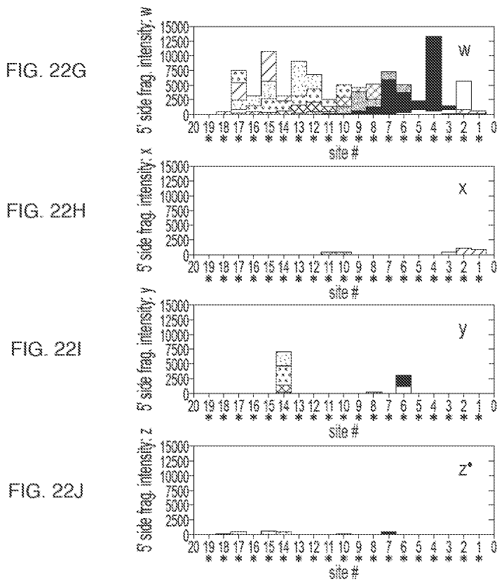

The dissociation rules and efficiency associated with EDD of ONTs that have undergone typical modifications were examined. An electron beam with K^{e}=35 eV and a nominal electron beam intensity of 3000 nA at Al was established. The samples were injected into the LC to obtain the EDD spectra in the targeted MSMS operation. FIGS. 21 and 22A-J show the EDD spectra with fragment density charts for all fragment types.

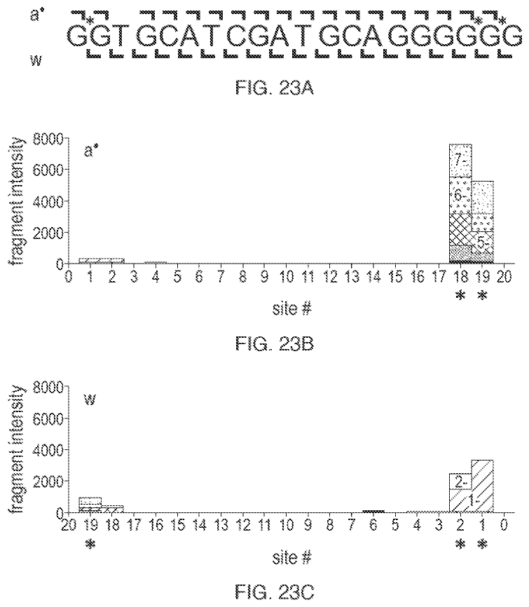

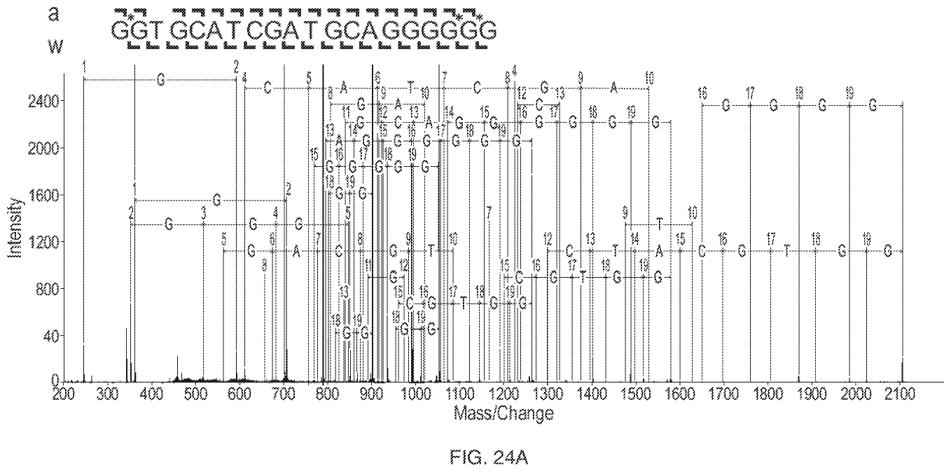

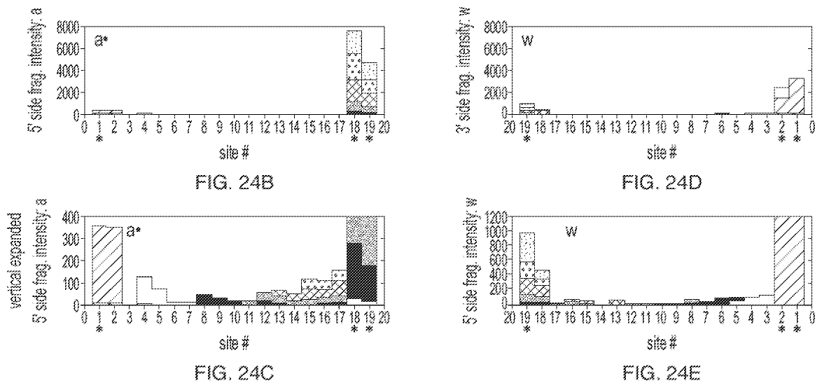

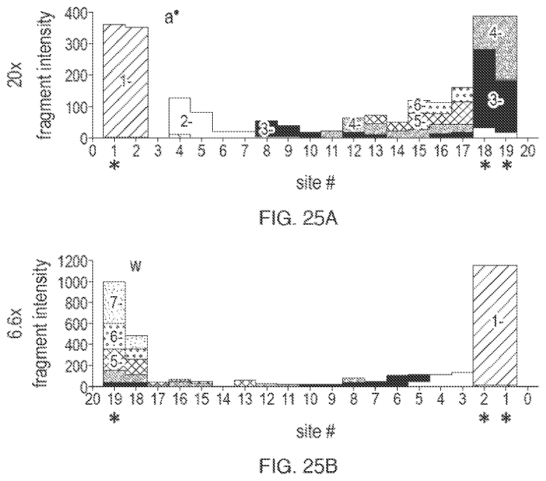

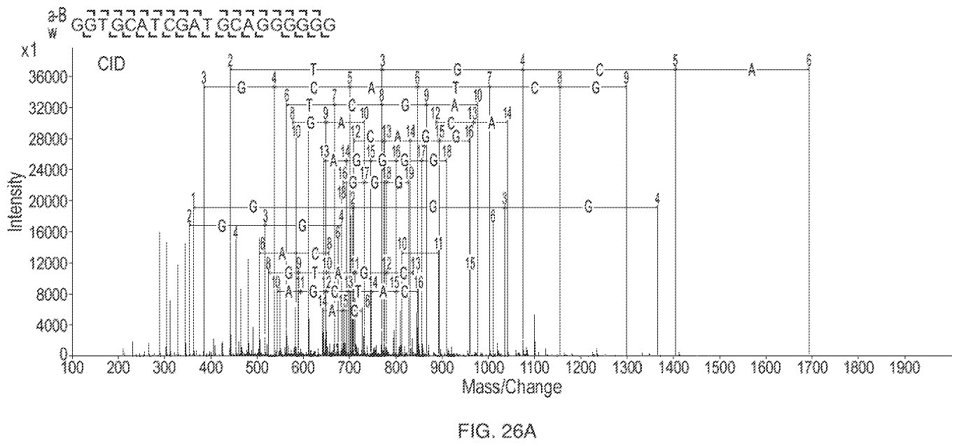

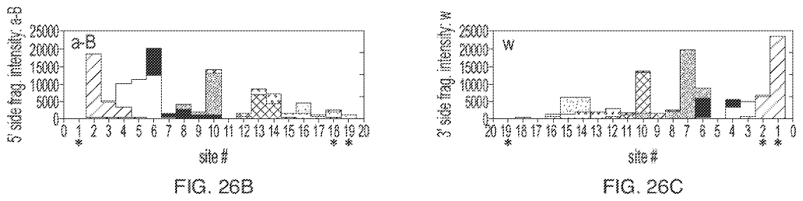

For DNA20-PS, the fragment types a and w were dominant, which was the same as DNA-PO, but the spectrum of the PS form showed significantly low CRS and outstandingly high dissociation efficiency. When PS was partially substituted in DNA-PO around the termini (DNA20-POPS), the fragments cleaved at the PS portions were 100 times more intense than those at the PO (FIGS. 23A-C and 24A-E). Although the signal intensity was weak at the PO portions, the spectrum can be sequenced using a^{⋅} and w fragments (FIGS. 23A and 25A-B). On the other hand, CID did not show such a significant PO/PS difference in dissociation efficiency (See, FIG. 26A-C).

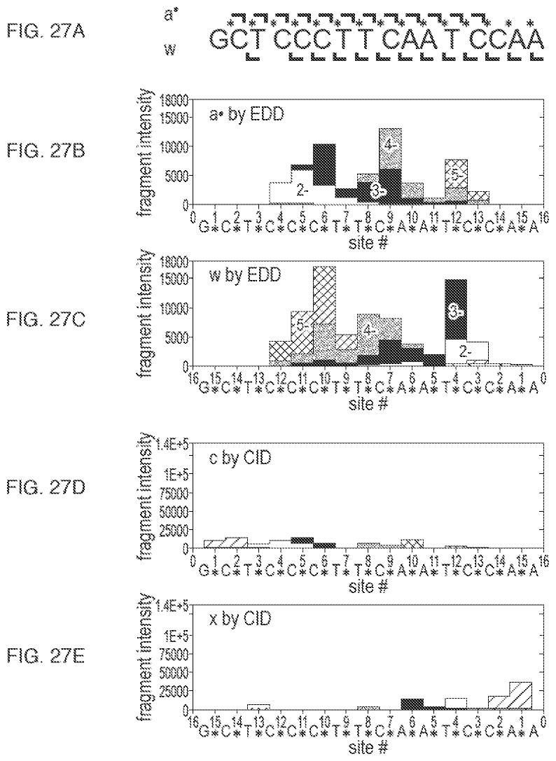

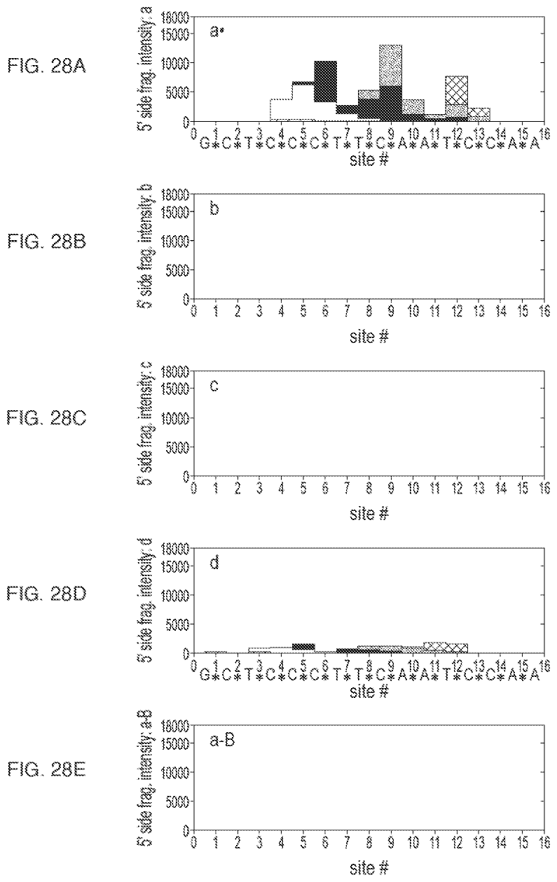

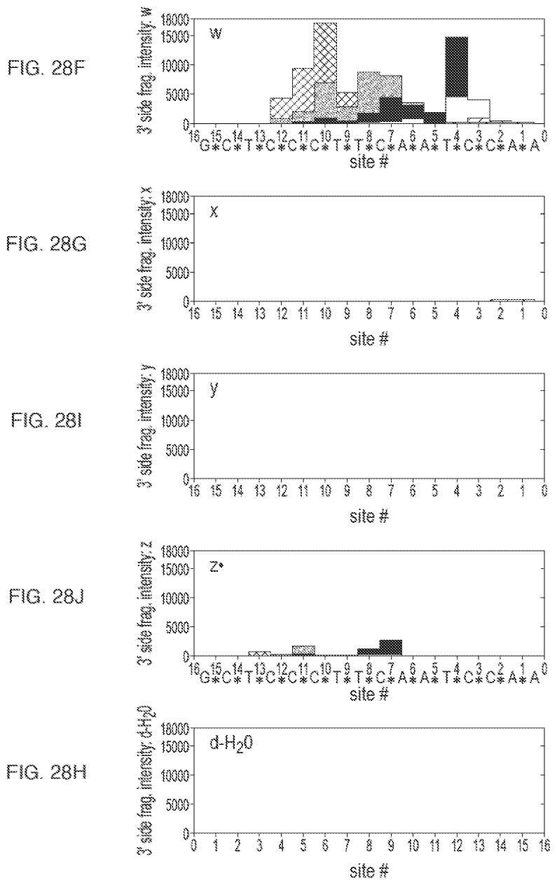

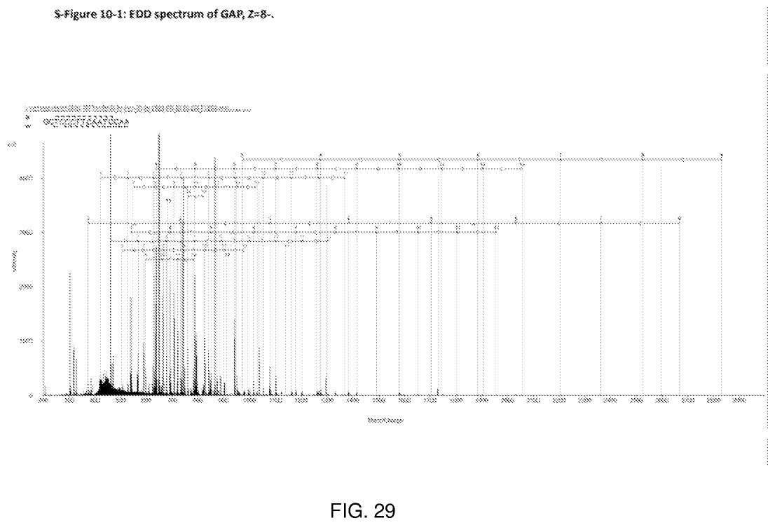

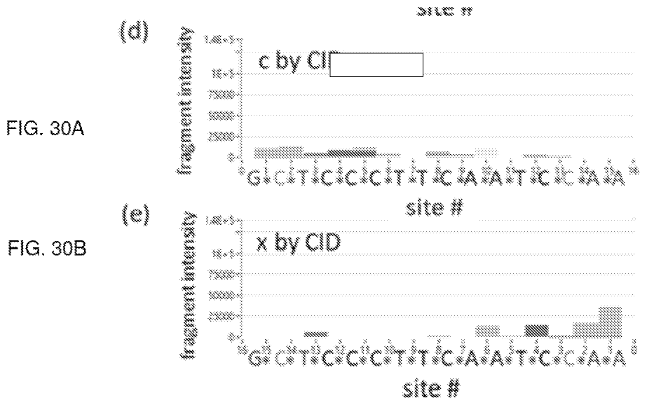

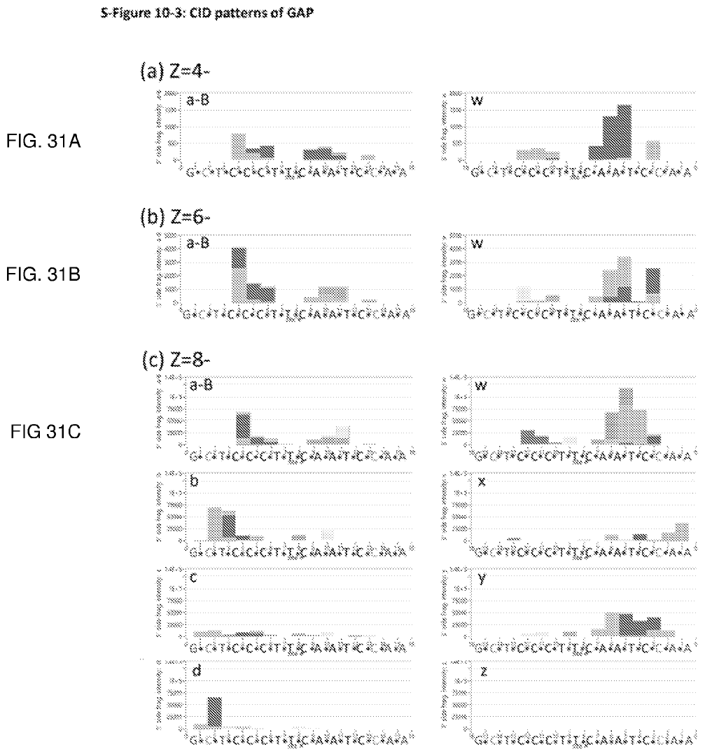

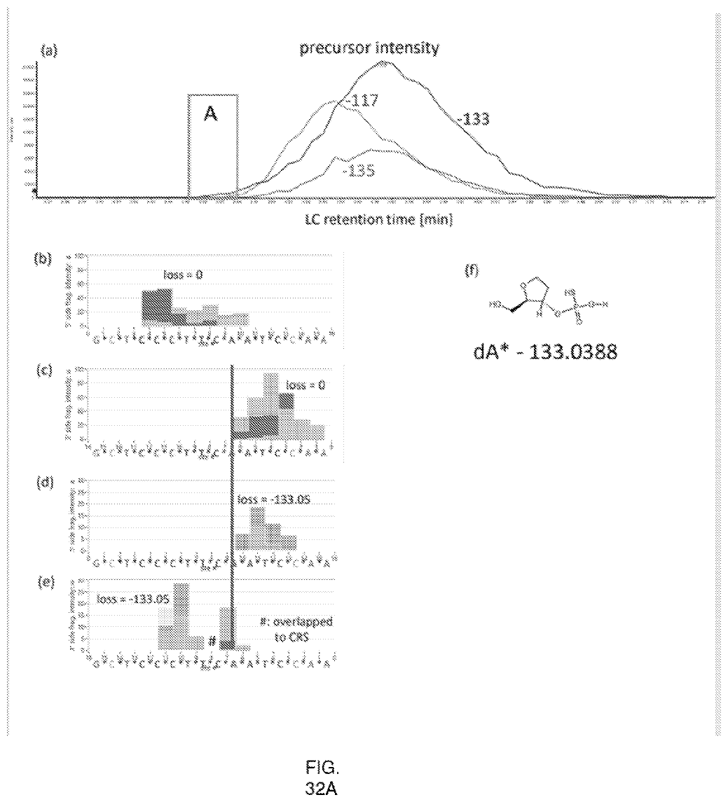

FIGS. 27A-E and 28A-H show the fragment intensity charts of oligonucleotides with locked ribose near the termini (GAP), i.e., the terminal GCT and CAA are locked, which are extracted from the plasma EDD spectra (FIG. 29). The data showed that dissociation at the locked portions was strongly suppressed in any fragment type. Although the intensities were weak, w fragments at the locked portions were detected (e.g. FIG. 28-A-J). The locked portion was not dissociated well by EDD, but CID produced fragments. It was observed that the primary fragment types generated via CID were not standard a-B and w fragments. Rather, b, c, d, x, and y fragments were observed (See, FIGS. 30A-B and 31A-C).

Since the locked ribose was introduced near the terminal in ONTs, CID and EDD can be complementary, i.e., CID sequences near the termini and EDD sequences in the middle portion of the ONT can be determined.

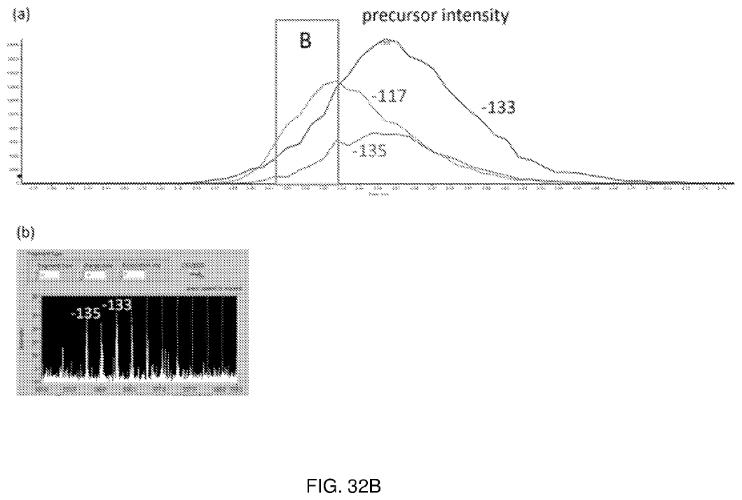

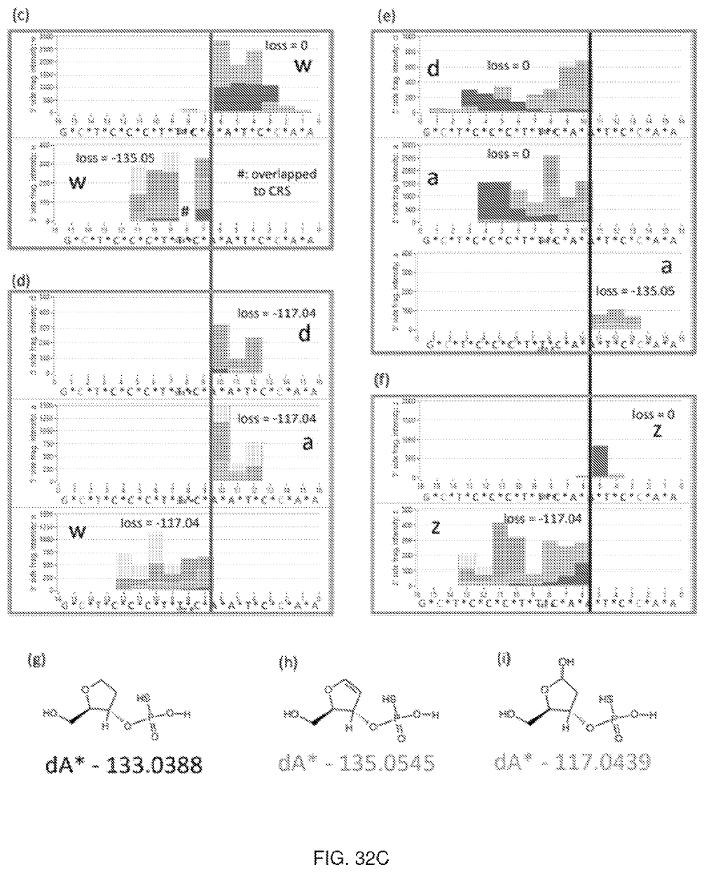

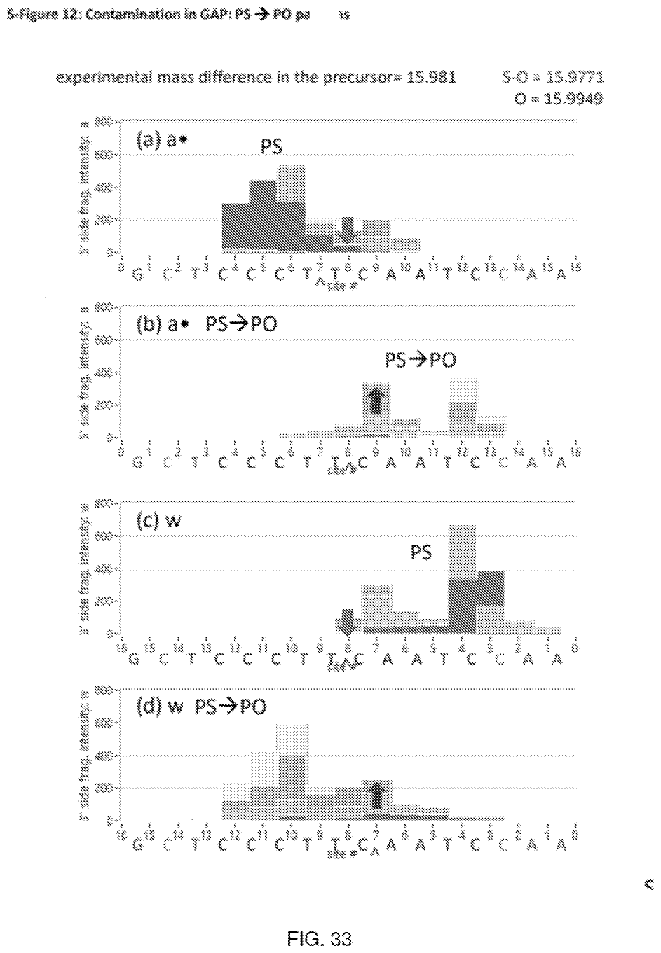

Impurities in the degraded GAP sample were surveyed by LC-MSMS (See, FIGS. 32A-C and 33). One observed change was an adenine loss (−A) from the precursor, which showed different patterns with −135, −133, and −117 Da. These precursors were not isolated by Q1′ mass filter, which was operated in a low-resolution mode and a 3 m/z window, nor did LC separated the −135 precursor or the −133 precursor well. EDD spectra were obtained by targeted acquisition (FIG. 32A-C). By summing the different portions of the LC elution peaks, the EDD spectra for each precursor were enhanced (See, FIG. 32A, 32B).

The loss of sulfur from PS in the GAP sample was also surveyed (e.g. FIG. 33). The experimental loss I the precursor ions was 15.981, which matched the mass difference between a sulfur atom and an oxygen atom, which confirmed the presence of PO-substituted PS. FIGS. 33a,c show the sequencing results for a and w fragments by the unmodified GAP molecular structure. FIGS. 33b,d show the sequencing results for a and w fragments, but one PS in the fragments was changed to PO. The modified position was distributed between sites 6 and 13 and sites 7 and 8 were heavily modified.

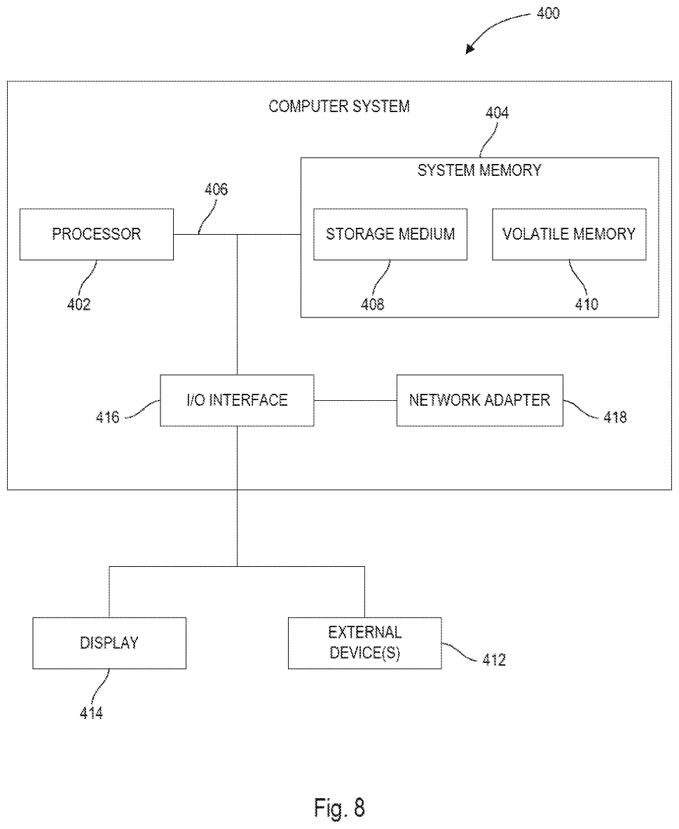

Referring now to FIG. 8, a computer system 800 is shown in accordance with an exemplary embodiment. In some embodiments, the computer system 800 serves as the controller 222.

As used herein a computer system (or device) is any system/device capable of receiving, processing, and/or sending data. Examples of computer systems include, but are not limited to personal computers, servers, hand-held computing devices, tablets, smart phones, multiprocessor-based systems, mainframe computer systems, and distributed cloud computing environments that include any of the above systems and the like

As shown in FIG. 8, the computer system 800 includes one or more processors or processing units 802, a system memory 804, and a bus 806 that couples various components of the computer system 800 including the system memory 804 to the processor 802.

The system memory 804 includes a computer readable storage medium 808 and volatile memory 810 (e.g., Random Access Memory, cache, etc.). As used herein, a computer readable storage medium includes any media that is capable of storing computer readable program instructions and is accessible by a computer system. The computer readable storage medium 808 includes non-volatile and non-transitory storage media (e.g., flash memory, read only memory (ROM), hard disk drives, etc.). Computer readable program instructions as described herein include program modules (e.g., routines, programs, objects, components, logic, data structures, etc.) that are executable by a processor. Furthermore, computer readable program instructions, when executed by a processor, can direct a computer system (e.g., the computer system 800) to function in a particular manner such that a computer readable storage medium (e.g., the computer readable storage medium 808) comprises an article of manufacture. Specifically, when the computer readable program instructions stored in the computer readable storage medium 808 are executed by the processor 802, they create means for implementing various functions described herein.

The bus 806 may be one or more of any type of bus structure capable of transmitting data between components of the computer system 800 (e.g., a memory bus, a memory controller, a peripheral bus, an accelerated graphics port, etc.).

In some embodiments, as depicted in FIG. 8, the computer system 800 may include one or more external devices 812 and a display 814. As used herein, an external device includes any device that allows a user to interact with a computer system (e.g., mouse, keyboard, touch screen, etc.). An external device 812 and the display 814 are in communication with the processor 802 and the system memory 804 via an Input/Output (I/O) interface 816.

The display 814 may show a graphical user interface (GUI) that may include a plurality of selectable icons and/or editable fields. A user may use an external device 812 (e.g., a mouse) to select one or more icons and/or edit one or more editable fields. Selecting an icon and/or editing a field may cause the processor 802 to execute computer readable program instructions stored in the computer readable storage medium 808. In one example, a user may use an external device 812 to interact with the computer system 800 and cause the processor 802 to execute computer readable program instructions relating to the various functions described herein.

The computer system 800 may further include a network adapter 818 which allows the computer system 800 to communicate with one or more other computer systems/devices via one or more networks (e.g., a local area network (LAN), a wide area network (WAN), a public network (the Internet), etc.).

While various embodiments have been illustrated and described in detail in the drawings and foregoing description, such illustration and description are to be considered illustrative or exemplary and not restrictive; embodiments of the present disclosure are not limited to the disclosed embodiments. Other variations to the disclosed embodiments can be understood and effected by those skilled in the art in practicing embodiments of the present disclosure, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

What is claimed is:

1. A method of performing electron detachment dissociation (EDD) and negative electron induced dissociation (EID) in mass spectrometry, comprising:
introducing a plurality of negatively charged analyte ions into an ion trap positioned in a chamber and trapping said negatively charged analyte ions in a reaction region of said ion trap,
introducing a buffer gas into the chamber,
using an electron source positioned in the chamber and external to the ion trap to generate electrons, and
accelerating the electrons to form an electron beam and introducing the electron beam into the ion trap such that the accelerated electrons are capable of ionizing at least a portion of molecules of the buffer gas to generate a plurality of positively charged ions,
wherein said accelerated electrons interact with at least a portion of the analyte ions trapped in said reaction region to cause electron detachment dissociation (EDD) and negative electron induced dissociation (EID) thereof, thereby generating a plurality of fragment product ions.

2. The method of claim 1, wherein the accelerated electrons have a kinetic energy greater than about 25 eV when nitrogen, neon, and krypton are used as the buffer gas.

3. The method of claim 1, wherein the accelerated electrons have a kinetic energy greater than about 50 eV when helium is used as the buffer gas.

4. The method of claim 1, wherein said positively charged ions comprise any of a nitrogen molecular ion, a helium ion, a neon ion, and a krypton ion.

5. The method of claim 4, wherein said electron kinetic energy is in a range of about 30 eV to about 50 eV when nitrogen, neon, and krypton are used as the buffer gas.

6. The method of claim 4, wherein said electron kinetic energy is in a range of about 50 eV to about 90 eV when helium is used as the buffer gas.

7. The method of claim 6, wherein said nitrogen molecular ion comprises N₂⁺ and N₂H⁺, said helium ion comprises Het, said neon ion comprises Ne⁺, and said krypton ion comprises Kr⁺.

8. The method of claim 1, wherein said ion trap comprises:
a branched RF ion trap having a longitudinal passageway extending from an inlet through which the negatively charged analyte ions can enter the trap to an outlet through which the fragment product ions can exit the trap; and
a transverse passageway intersecting said longitudinal passageway at said reaction region, said transverse passageway having an inlet for receiving said electron beam.

9. The method of claim 8, wherein said branched RF ion trap comprises two sets of L-shaped rods separated axially from one another, wherein said set of the L-shaped rods is arranged according to a multipole configuration and the method further comprises:
applying RF voltages to said rods so as to generate an electric RF field for confining said analyte ions within said reaction region.

10. The method of claim 1, further comprising using at least one magnet positioned in the chamber to confine the electron beam.

11. The method of claim 1, wherein the electron beam provides an electrostatic potential well that confines the positively charged ions within the reaction region.

12. A mass spectrometer, comprising:
an ion source for receiving a sample and ionizing one or more analytes to generate a plurality of negatively charged analyte ions,
a chamber including a buffer gas and an ion trap for trapping the negatively charged analyte ions,
an electron source positioned in the chamber and external to the ion trap for generating electrons, and
at least one magnet positioned in the chamber for forming the electrons into an electron beam that is introduced into the ion trap,
wherein the electron beam is capable of ionizing at least a portion of the molecules of the buffer gas to generate a plurality of positively charged ions, and
wherein the electrons interact with at least a portion of the analyte ions to cause electron detachment dissociation (EDD) and negative electron induced dissociation (EID) thereof, thereby generating a plurality of fragment product ions.

13. The mass spectrometer of claim 12, wherein the ion source comprises an electrospray ion source.

14. The mass spectrometer of claim 12, further comprising:
a plurality of rods arranged in a multipole configuration to form an axial pathway and a transverse pathway that is perpendicular to the axial pathway, wherein the negatively charged analyte ions are introduced into the ion trap via the axial pathway and the electron beam is introduced into the ion trap via the transverse pathway; and
an RF voltage source for applying RF voltages to the plurality of rods.

15. The mass spectrometer of claim 14, wherein the plurality of rods includes a first set of L-shaped rods and a second set of L-shaped rods arranged in a quadrupole configuration.

16. The mass spectrometer of claim 15, wherein the rods are L-shaped.

17. The mass spectrometer of claim 12, wherein the positively charged ions comprise any of a nitrogen molecular ion, a helium ion, a neon ion, and a krypton ion.

18. The mass spectrometer of claim 17, wherein the nitrogen molecular ion comprises N₂⁺ and N₂H⁺, said helium ion comprises He⁺, said neon ion comprises Ne⁺, and said krypton ion comprises Kr⁺.

19. The mass spectrometer of claim 12, wherein the electron kinetic energy is in a range of about 25 eV to about 50 eV when nitrogen, neon, and krypton are used as the buffer gas.

20. The mass spectrometer of claim 12, wherein the electron kinetic energy is in a range of about 50 eV to about 90 eV when helium is used as the buffer gas.
